(19) United States
(12) Patent Application Publication
(10) Pub. No.: US 2023/0391209 A1
(43) Pub. Date: Dec. 7, 2023

(54) STATIC TYPE WPT COUPLING DEVICE WITH YIELDING MECHANISM WITH CONTROLLED AND ADJUSTABLE DEFORMATION FOR STABILIZATION AND BLOCKING

(71) Applicant: Moby Health S.r.L., Napoli (IT)

(72) Inventor: Francesco LA MARCA, Ottaviano (NA) (IT)

(21) Appl. No.: 18/000,913

(22) PCT Filed: Jun. 7, 2022
(86) PCT No.: PCT/IT2020/000047

§ 371 Date: Dec. 6, 2022

(51) Int. Cl. B60L 53/12; B60L 53/34

(52) U.S. Cl. CPC B60L 53/12; B60L 53/34

(57) ABSTRACT

The device object of the invention creates a coupling standard between the transmitting/receiving plate that facilitates the application of WPT charging to public charging. The device couples the receiving plate to the plate for the WPT electrical transmission and ensures the permanent desired specular and parallel correspondence and the desired inter-distance, optimal for the WPT energy transfer from the transmitting plate to the receiving plate. The device is composed of a male part and a female part. Static type WPT coupling derives from the male-female junction, at the distance and with the operating alignment required for the efficiency of the charging system, with stabilization and also inhibition of decoupling. The device is, in fact, also composed by a yielding mechanism with controlled and adjustable deformation for self-adaptation to different operating conditions, thus guaranteeing undisturbed alignment, parallelism and inter-distance between the said plates.

### FIELD OF THE TECHNIQUE TO WHICH THE INVENTION REFERS

The field of art to which the invention refers is that of applications of Wireless Power Transfer (WPT) technology for charging that allows transfer electrical energy from the source to the user via a magnetic/electric/electromagnetic field, without any contact between the two. Wireless power transfer therefore takes place in the coupling field between a transmitter (or primary) and a receiver (or secondary).

Pre-Existing Technique Status Inherent the Reference Field of the Invention

WPT charging technology of an electrical device requires that the transmission plate, which incorporates the transmitting coil, power connected, and the receiving plate, which incorporates the receiving coil, are, and remain, aligned and at the correct inter-distance respecting a minimum predefined tolerance. Numerous applications require car storage batteries recharging by transfer between a transmitting plate embedded in the floor and a receiving plate located on the bottom of the car.

On the other hand, inductive charging of electrical devices for domestic use is also obtained by resting a part of the device on an inductive charging base. In known applications, the device always has on board the receiving plate and the success of the WPT transmission is entrusted to the precision with which is positioned the device respect to the charging point that incorporates the transmitting plate.

Invention Details and Advantages Introduced Compared to the Existing Technique

WPT recharging advantages include the best safety of electrical components from external agents and corrosive problems and the reduced incidence of insulation failures, particularly in the event of frequent connections and interruptions. WPT charging is therefore very useful externally for public charging of electrical devices.

Considering the position of the device to be recharged with respect to the horizontal plane, the technological solutions applied so far relate bottom-up recharging with the exception of limited lateral charging applications. By way of example and not limited to, the scarce diffusion of the WPT cars' recharge is given precisely by the difficult applicability to recharge for public use. The charging plates, in fact, must be embedded in the road surface or fixed above it. The receiving plates in the underbody of electric cars and the transmission plates are still characterized by unequivocal correspondence, so the induction charging stations do not work for car models of different manufacturers.

The automotive industry has already agreed on some common transmission standards (e.g. 85 kilohertz energy). The challenge of standardization, however, is represented by the development of a transmission plate which allows the maximum possible tolerance regarding the parking of the vehicle. In fact, to be efficient the energy transfer, the car must be stopped exactly above the said plate. Furthermore, the standardization of the system must bear in mind the different dimensions of the vehicles and the different types of receiving coils. The adduced example makes clear that the same problems are foreseen for electric motorcycles, electric bicycles, electric scooters public recharging imagining transmitting plates embedded in adequate supports/guides on the floor that would hardly have a correspondence with the wheels or with other components, e.g. platform, stand etc. of vehicles of different brands. Furthermore, the above-mentioned criticalities are also found in the hypothesis of lateral coupling, e.g. receiver plate allocated in the car door and wall-mounted transmitter plate. An efficient inductive coupling would require that the associated vehicle must be positioned, and remain, parallel to the wall in compliance with the predefined tolerances, with any obvious burden relating to the need for a perfect parking maneuver, also influenced by the shape of the vehicle, etc.

With reference to the lack of parking spaces in urban areas, the main obstacle to inductive charging stations diffusion is, therefore, linked to the objective difficulty of constraining the usability of a parking space in favor of a single type of car or other electric vehicle.

The device object of the invention creates a coupling standard between the transmitting/receiving plate that facilitates the application of WPT charging to public charging.

The appliance is made up of a male part and a female part.

The male part of the appliance is made up of a bracket to which are rigidly connected a solid body, functional to hook and lock in the corresponding female part, and a receiving plate, connected by cable to the converter installed on board the vehicle.

The female part of the appliance is composed of a bracket which incorporates a functional track for hooking and locking the male part, and a transmitting plate connected to the converter installed on the charging infrastructure (by way of example, but not exhaustive, a charging station).

The static-type WPT coupling derives from the male-female junction, at the distance and with the operating alignment required for the efficiency of the charging system, with stabilization and also inhibition of decoupling. The device, in fact, is also made up of a yielding mechanism with controlled and adjustable deformation for self-adaptation to different operating conditions, thus guaranteeing undisturbed alignment, parallelism and inter-distance between the said plates. With the insertion of the male part in the female part, micro-movements of self-adaptation roto-translational of the female part are automatically determined facilitating the insertion of the male part up to the locked position. These properties are particularly advantageous when the application of the invention requires the jointing device to react repeatedly to different operating situations, such as repeated inappropriate stresses by users, or in the case of public use, excessive thrusts or tractions of the male part, or bumps or tugs of the charging devices (e.g. of a motorcycle, a scooter . . . ). Pending the standardization of the transmission plates by the manufacturers of cars, motorcycles, etc., the invention offers the possibility that the same parking space can be served by different standards of transmission plates for the corresponding cars. Subsequently, standardized the transmitting plate, the advantage of the invention will be the inductively rechargeable for cars, motorcycles, etc in the same parking space without restrictions of dimensions, volumes, ground clearance etc.

As a result of the application of the invention, parking spaces may also be available for parking both electric cars with conductive and inductive charging, as a charging station can accommodate both electrical sockets for conductive charging and plates for inductive charging.

Another application of particular advantage is in the nautical field, ensuring the electric recharge of electric boats by inductive coupling of the transmitter plates, installed on a charging station (with the undoubted advantage of greater resistance to external agents), to the receiver plate, connected with cable to the converter on board the boat.

The invention can be industrially produced by being composed of elements that can be manufactured with processes also available for mass production.

The device can be made in various standard formats (e.g. Large, Midi, Mini).

The combination of the female and male parts is extremely flexible, only for example:
male part, which houses the receiving plate, connected in a non-rigid way to the vehicle to be recharged and female part, which houses the transmitting plate, rigidly connected (screwing, welding, gluing, cementing) to fixed bodies of different workmanship and materials (pillars, bars, wardrobes, walls . . . ): example FIGS. 15, 16 and 17;
male part, which houses the receiving plate, rigidly connected to the vehicle to be recharged (screwing, welding, gluing) and female part, which houses the transmitting plate, rigidly connected to fixed bodies of different workmanship and materials (pillars, bars, wardrobes, walls . . . ): example FIGS. 19, 20 and 21;
male part, which houses the transmitting plate, connected in a non-rigid way to fixed bodies of different workmanship and materials (pillars, bars, cabinets, walls . . . ) and female part, which houses the receiving plate, rigidly connected to the vehicle to be recharged (screwing, welding, gluing): example FIG. 18.

The desired inter-distance between the receiving and transmitting plates as well as the desired elasticity of the female part are additionally adjustable during operation according to the conditions desired for the operation.

There is no known so far device that realizes the functionality of the invention. The invention consists of a device composed of a male part and a female part. The male part α, made of metal and/or polymers, consists of a rigid SFα bracket, to which are rigidly connected:
a shaped pin SP which fits into a special guide in the GD guide embedded in the rigid bracket SFβ of the female part β, for this sliding to the position of arrival SPA, in which it remains blocked by the action of the PCB and/or PM locking pistons. The SP plug is provided with IPCB and IPBM circular grooves for respectively stopping of PCB and/or PBM locking pistons released by the female part β;
an EAα receiving plate, and related components, for WPT charging of an electrical device;
a CL collar, circular or quadratic for the eventual rigid anchoring of the rigid bracket SFα to an electrical device (for example at the scooter rod);
SPEA shims applicable to and/or removable from the rigid SFα bracket to record the inter-distance between the EAα receiving plate and the EAβ transmitting plate;
SMP magnetic presence sensors/detectors allocated in the SP pin or in the rigid SFα bracket, corresponding in position to the SMP magnetic presence sensors/detectors allocated respectively in the rigid SFβ bracket.

The female part β, made of metal and/or polymers, consists of:
a rigid SFβ bracket equipped with:
   a GD recessed guide specific for inserting the SP pin;
   FCB hole, for the passage of PCB piston of blocking device CB;
   FBM hole for the passage of PBM piston of alternative BM blocking device;
   recess for drowning spring presser with BS ball;
   FPC holes for screwing the PRF steel pins to the SFβ bracket. The FPC holes of the SFβ bracket start from the base of the IFPC grooves. The width and depth of the IFPC grooves allows the comfortable housing of the CR cylindrical elements of PRF and the deformation of the same in compliance with the functionality required to the jointing device;
   FFC holes for fixing the minor cylindrical solid base FC;
   an EAβ transmitter plate, and related components, for the WPT recharge of an electrical device;
   SPEA shims applicable to and/or removable from the rigid SFβ bracket to record the inter-distance between the EAβ transmitting plate and the EAα receiving plate;
   PRF elastic pins, consisting of a cylindrical elastic CR body fixed on metal washers joined to steel pins, to be screwed into the corresponding FPC holes on the SFβ bracket and on the PR bracket, parallel to the SFβ bracket. The elastic characteristics of the cylindrical body CR allow the roto-translational micro-movements of the SFβ bracket with respect to the PR bracket;
   ASP thickness rings, applicable to and/or removable from the end of the PRF steel pins in the IFPC recess and/or to/from the end of the same pins emerging from the PR bracket, with consequent micro-regulation of the roto-translational movements of the SFβ bracket with respect to PR;
a rigid PR bracket equipped with:
   FFCB aperture for the passage/support of the FC conditionally controlled block;
   FCF holes for the integral screwing of the PR bracket to a fixed element (to which the PR bracket can however also be welded or cemented);
   FPC threaded holes for screwing the PRF steel pins to the PR bracket from which they come out net of the PR thickness;
a FC conditionally controlled block, screwed solidly to GD in the FFC holes, provided with:
   CIL hole for the passage of the PCB piston of the CB blocking device;
   AL flap for the control and regulation of the roto-translational micro-movements of the SFβ bracket with respect to the PR bracket;
an electromechanical block CB, screwed solidly to the major base of the solid FC in the FCIL holes, which, after consent received from the coupling of SMP magnetic presence sensors, releases PCB piston that crosses the CIL hole in FC, FCB hole in GD and stops in the IPCB recess in the SP pin, with mechanical locking of the same. The retraction of the PCB piston is electronically controlled by a plc/pc with various possibilities of interaction also in-cloud;
alternatively, a mechanical spring block BM connected solidly to GD, which, upon reaching the pin SP the target position SPA, releases the PBM piston which crosses the FBM hole in GD and stops in the IPBM recess in the same SP pin, with mechanical locking of the same. The retraction of the PBM piston as well as manual can be electromechanically controlled electronically by plc/pc with different possibilities of interaction also in-cloud;
alternatively, a spring presser with BS ball embedded in the GD lower surface where slides the SP pin for the mechanical brake of SP;
SMP magnetic presence sensors/detectors allocated in GD, in the SPA arrival position of the SP pin, or in the rigid SFβ bracket, corresponding in position to the SMP magnetic presence sensors/detectors allocated respectively in the SP pin or in the rigid SFα bracket.

In the GD guide recessed in the front of the SFβ bracket, the SP pin slides up to the target position SPA. The shape of the SP pin helps its conveyance inside the guide which, appropriately, in the initial part is characterized by a more or less accentuated chamfer depending on the operating conditions in which the device will find use, thus ensuring the insertion of the pin also in the case of conditions other than the normal operating one.

The SP pin is stopped in the arrival position SPA, its return has a mechanical impediment due to:
PCB piston which, operated by the CB blocking device after the consent received from the coupling of SMP magnetic presence sensors, advances and stops in the IPCB recess in GD, or to
PBM piston which, released by the spring of the BM locking device when SP arrives in SPA, enters the IPBM recess in SP, and/or to
spring presser with BS ball present in the floor of the guide in which the SP pin slides, released behind SP upon arrival in the SPA.

The SFβ bracket is connected to the PR bracket by 4 elastic pins PRF (however at least 3) screwed into the FPC holes. The elastic pins PRF consist of a cylindrical element CR fixed on metal washers joined to steel pins, to be screwed in the corresponding FPC holes on the brackets SFβ and PR.

The cylindrical elements CR are housed in the IFPC recesses of the SFβ bracket. The cylindrical element CR is composed of a vulcanized natural rubber cylinder (or any appropriate synthetic blend) or even a spring in harmonic steel. At the engage and at lock of the SP pin in GD, the elasticity and the consequential cylindrical element CR deformation allows roto-translational micro-movements of the SFβ bracket with respect to the PR bracket, thus damping the loads and tensile forces that may be exerted on the parts α and β of the mechanism (and/or also on the elements to which they are made integral).

The aforementioned rubber or harmonic steel spring, of which the cylindrical element CR is made, ensures that whenever the SP pin is disengaged by GD and therefore by the SFβ bracket, the rubber or the spring resumes the same starting characteristics without any permanent deformation and therefore the SFβ bracket returns to its original position.

These properties are particularly advantageous when the application of the invention requires the coupling device to react repeatedly to different operating situations, by way of example, but not limited to:—the repeated engagement/disengagement of vehicles on wheels (e.g. electric scooters, bicycles or other mobility devices) to/from a parking and charging column;—inappropriate user solicitations, such as excessive thrusts or tractions of the male part, or impacts or tugging of the bicycle/scooter plugged.

The deformation defined with reference to the morphological and structural properties of the PRF cylindrical CR elements is controlled by the components of the FC conditionally controlled block whose dimensions constrain the roto-translational micro-movements of the SFβ bracket, thus creating the desired articulation for the respect of the functionality required to the coupling device. Into the FFC holes of the SFβ bracket back wall is screwed the minor base of a cylindrical solid FC which previously has crossed the plate PR in the circular aperture FFCB. The cylindrical solid FC is integral with the SFβ bracket only. The solid FC is a single body composed of two overlapped cylinders with concentric bases, the cylindrical portion FCm with a diameter smaller than the diameter of the circular aperture FFCB and the cylindrical portion FCM with a diameter greater than the same aperture FFCB, so when FC crosses the aperture FFCB, the aforesaid cylindrical portions FCm and FCM will be respectively on this side and beyond the PR bracket.

The solid FC is crossed by the hole CIL, corresponding to the hole FCB, placed in continuation, for the passage of PCB piston of blocking device CB.

The major base of the cylindrical solid FC is provided with a lateral flap AL included in the space between two PRF pins emerging from the PR bracket, which limit their rotation.

The deformation defined with reference to the morphological and structural properties of the cylindrical element CR of PRF is:
controlled by the components of the FC conditionally controlled block, whose dimensions regulate the roto-translational micro-movements of the SFβ bracket:
   diameter at the base FCm: the greater or lesser size of the base diameter FCm affects the movement of FCm in FFCB, affecting the translational component parallel to PR of the roto-translational motion of the SFβ bracket;
   height FCm: the height of the cylindrical portion FCm determines the maximum inter-distance between the brackets SFβ and PR and therefore limits the translational component orthogonal to PR of the roto-translational motion of the bracket SFβ;
   AL: the greater or lesser distance between the external edges of AL and the PRF pins, which emerge from PR, affects the rotary component of the roto-translational motion of the SFβ bracket;
and micro-regulated by:
   ASP thickness rings applicable to or removable from the end of the PRF threaded steel pins emerging from the PR bracket, which leads to a reduction/increase of the distance between the edges of AL and the PRF pins,
   the screwing depth of the PRF steel pins in the SFβ bracket, due to the application or removal of ASP thick rings at/from the end of the same said pins inside the IFPC recess, which results an increase/reduction of the inter-distance between the SFβ and PR brackets, thus creating the desired articulation in observation to the required functionality.

The device described so far advantageously ensures to the receiver/transmitter plates the undisturbed specular correspondence and parallelism required for the desired WPT electricity transmission. The device is designed for the connection of different types of electro-mechanical lock, which ensure the same functions from different positions and/or with different types of controls. The electro-mechanical block CB and/or BM (if electromechanical) advantageously allows to operate the junction of the free body to the fixed body also by remote commands and/or from the cloud with numerous applications, such as by way of example, but not limited to, the authorization of the male part α to engage/disengage to/from the female part 3 only in favor of users registered for electric recharge and/or rental of the associated electrical devices.

### DRAWINGS DESCRIPTIONS

FIGS. 1-2 show the male component a of the invention

In FIGS. 3-4 is represented the SFβ bracket of the invention 3 component

In FIGS. 5-6 is represented the PR bracket of the invention 3 component

In FIGS. 7-8 is represented the FC conditionally controlled block of the invention;

FIGS. 9-10 show the component R of the invention

In FIGS. 11-12 is represented the engage of the male component a into the component R of the invention

In FIGS. 13-14 with simplified graphic example are represented the main roto-translational micro-movements of the SFβ bracket with respect to the PR bracket.

FIGS. 15-16-17 show the application of the invention for the coupling of the receiving plate—housed in the α part of the invention connected by cable with the converter on board the vehicle to be recharged (car)—with the transmitting plate, housed in the β part of the invention and rigidly connected to a charging pillar.

FIG. 18 shows the application of the invention to the coupling of the receiving plate—housed in the β part of the invention and rigidly connected to the vehicle to be recharged (motorcycle)—with the transmitting plate, housed in the α part of the invention and connected with cable to a charging pillar.

FIGS. 19-20-21 is represented the application of the invention for the coupling of the receiving plate—housed in the α part of the invention rigidly connected to the vehicle to be recharged (scooter, mountain bike)—with the transmitting plate, housed in the β part of the invention and rigidly connected to a charging pillar. In all the above figures are used the abbreviations reported in the description of the invention.

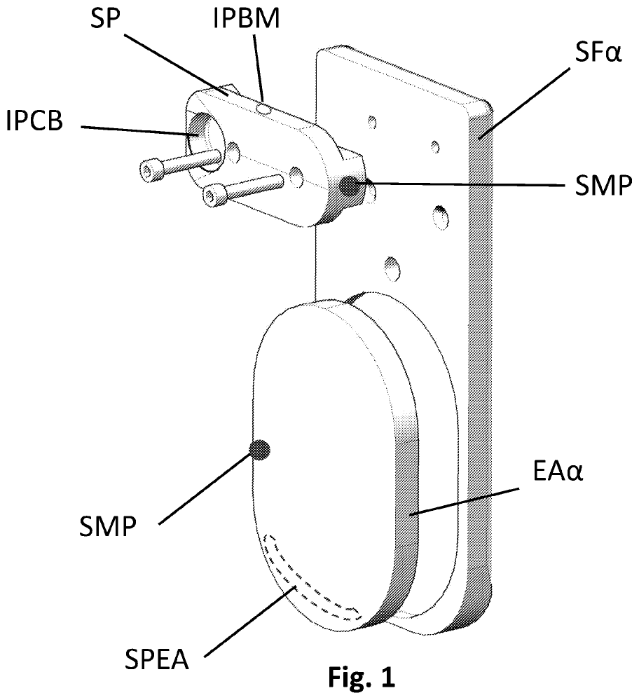

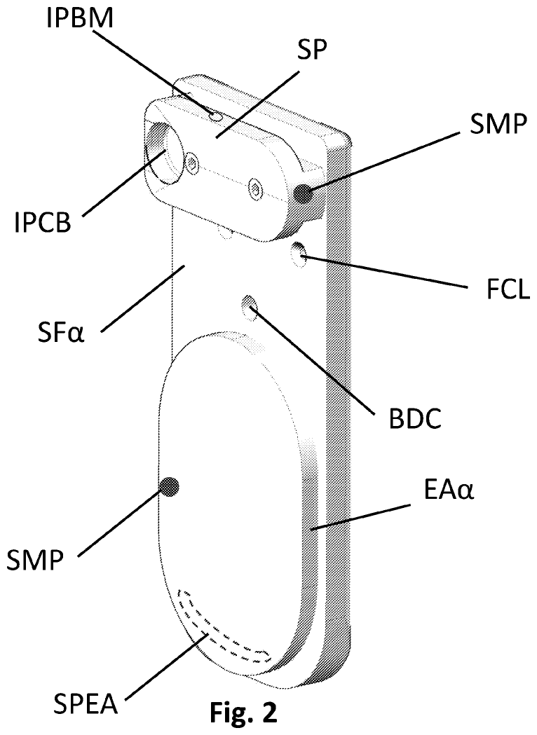

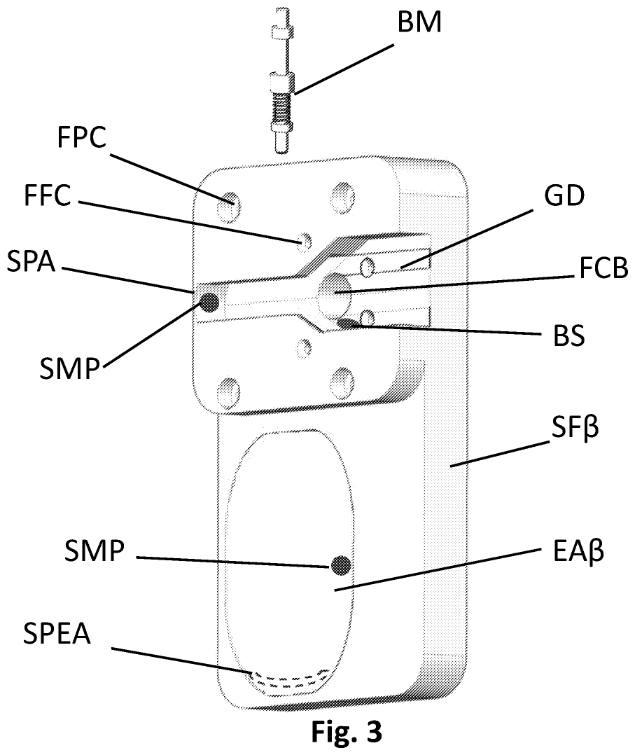

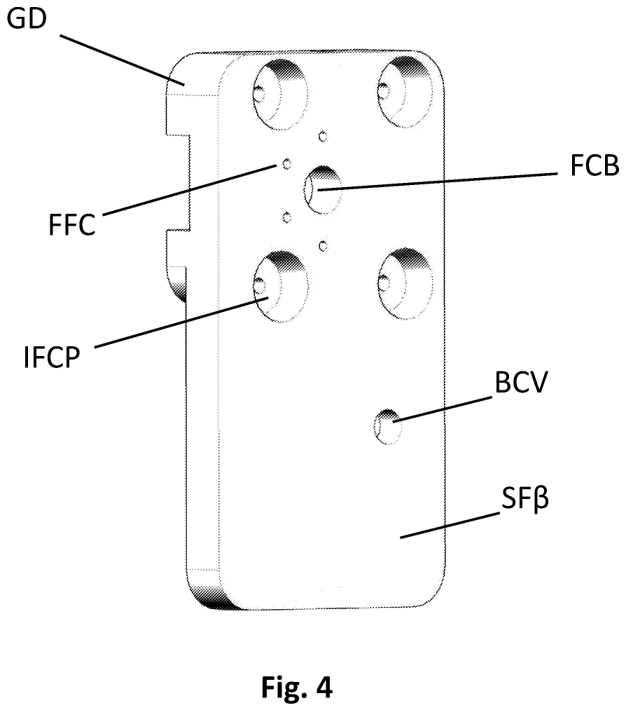

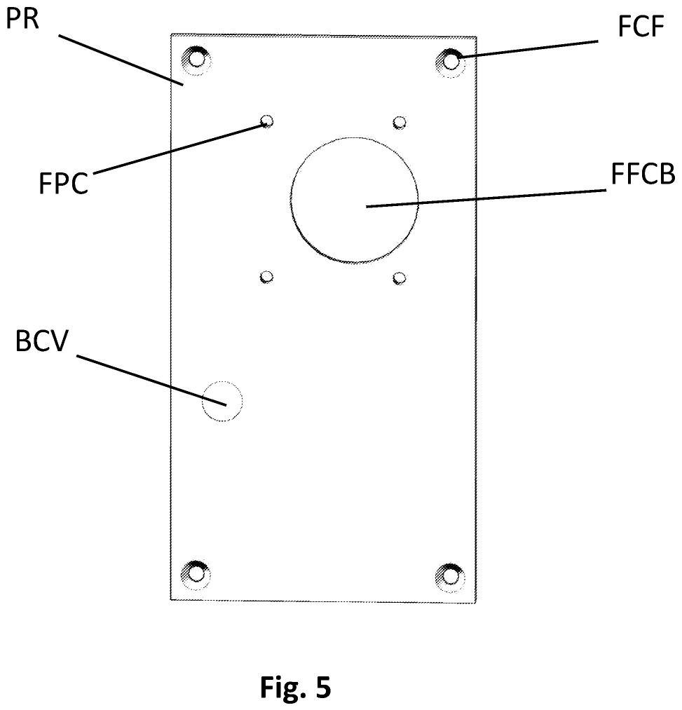

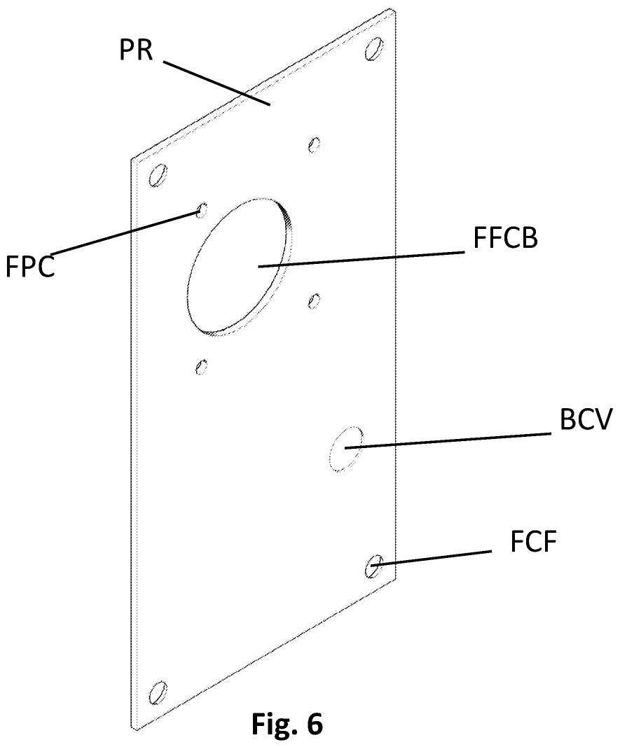

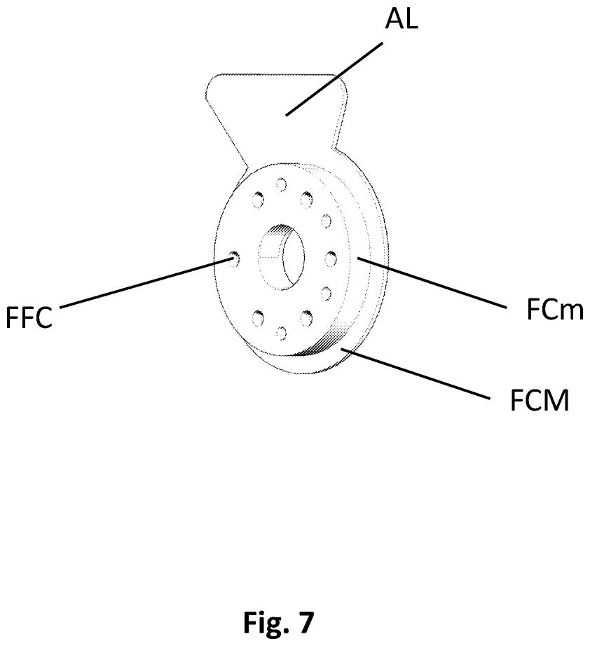

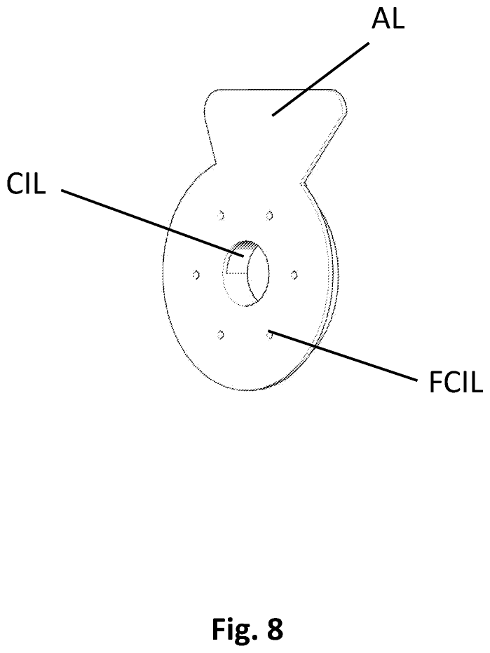

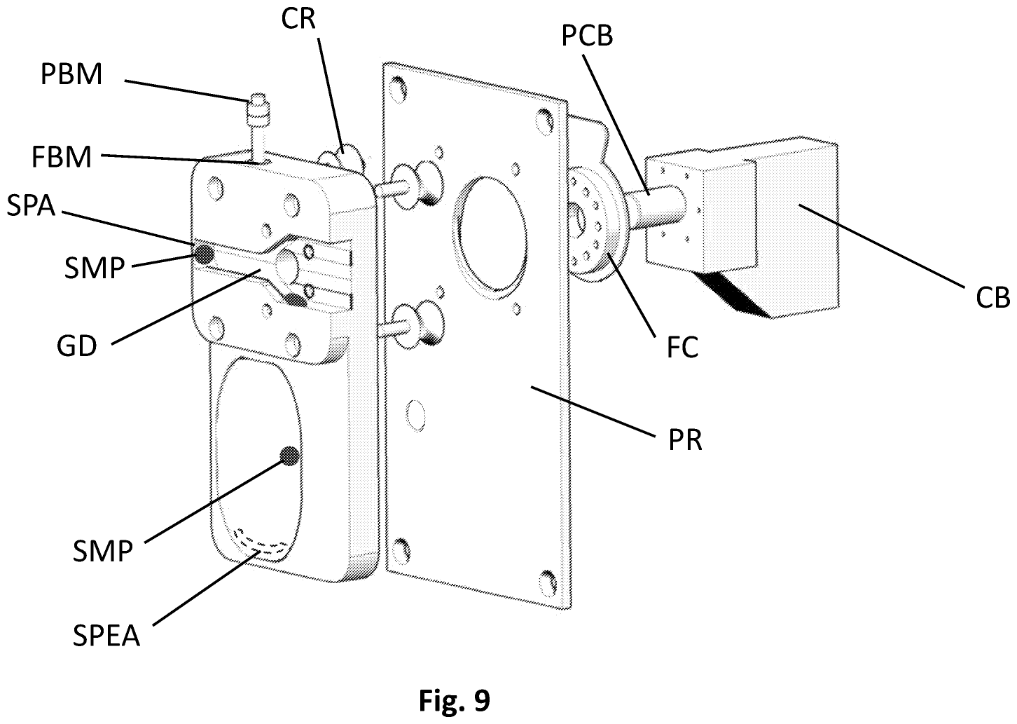

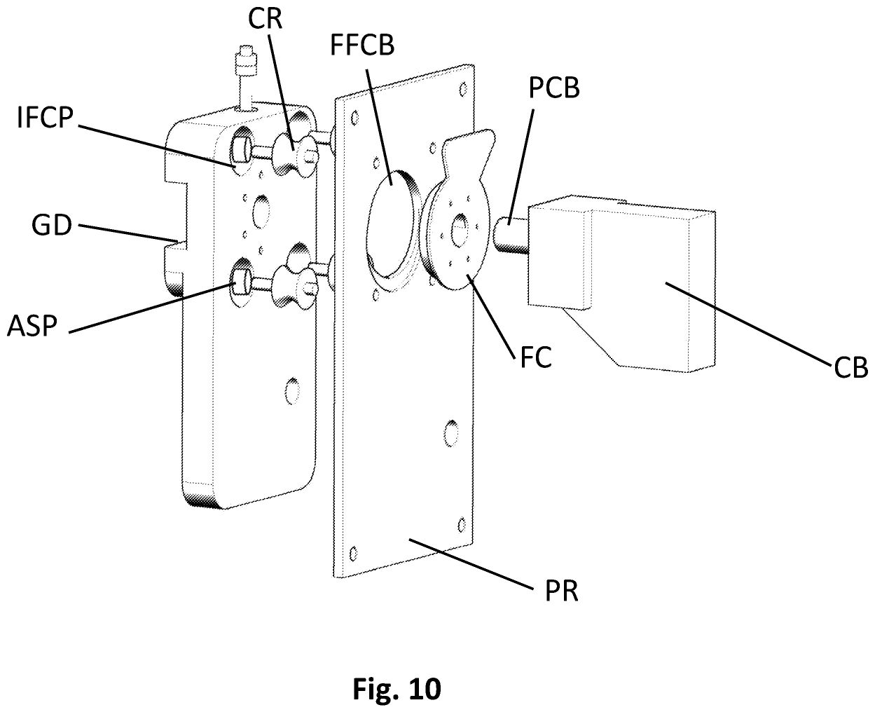

### DESCRIPTION OF INVENTION APPLICATION

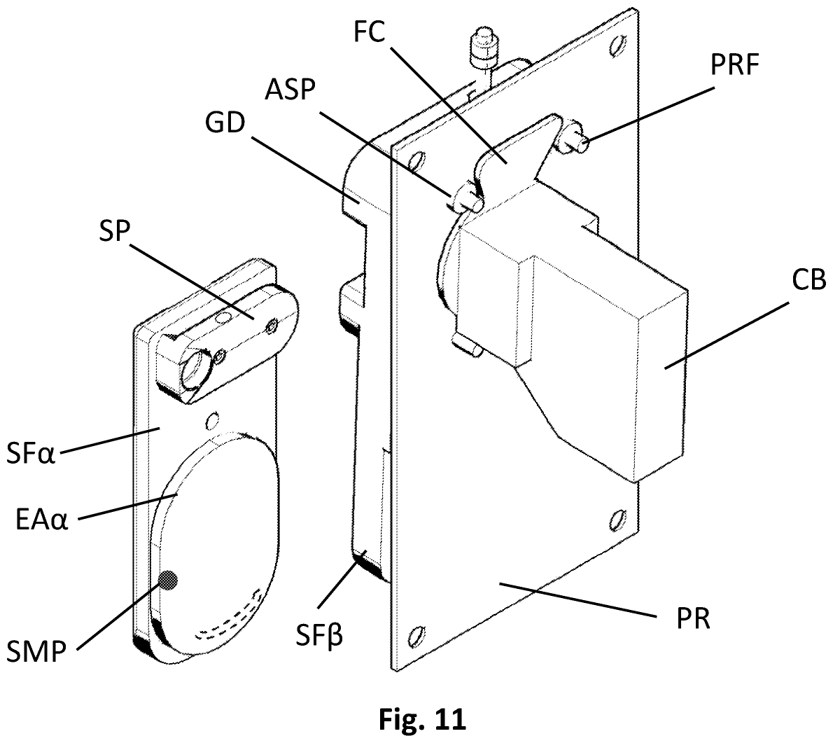

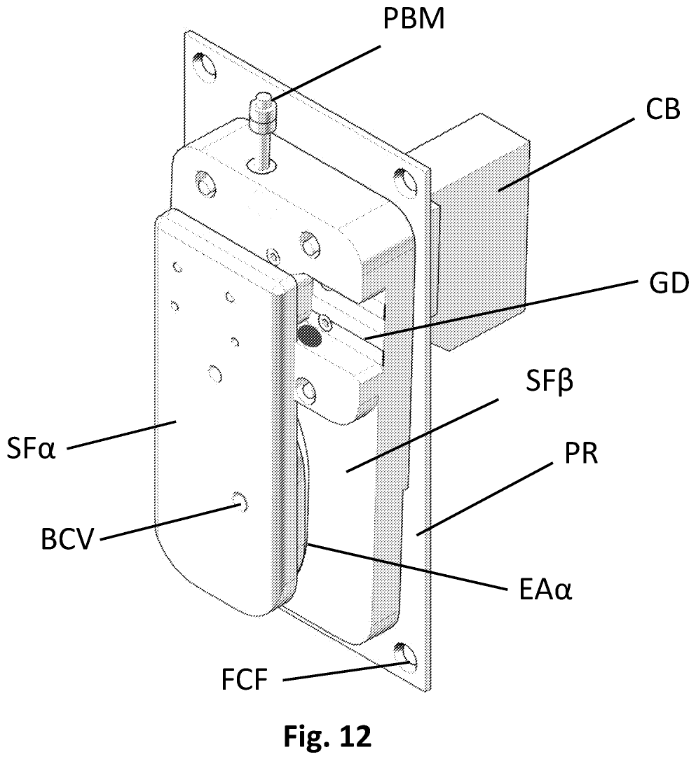

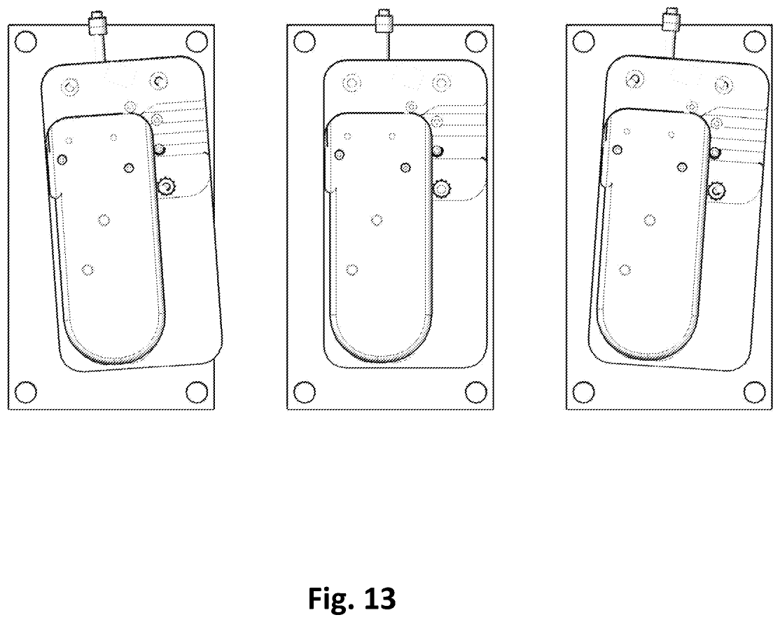

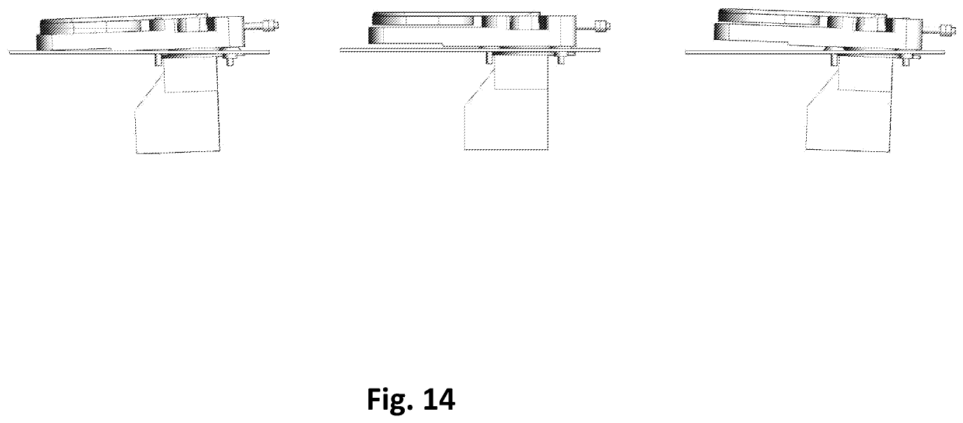

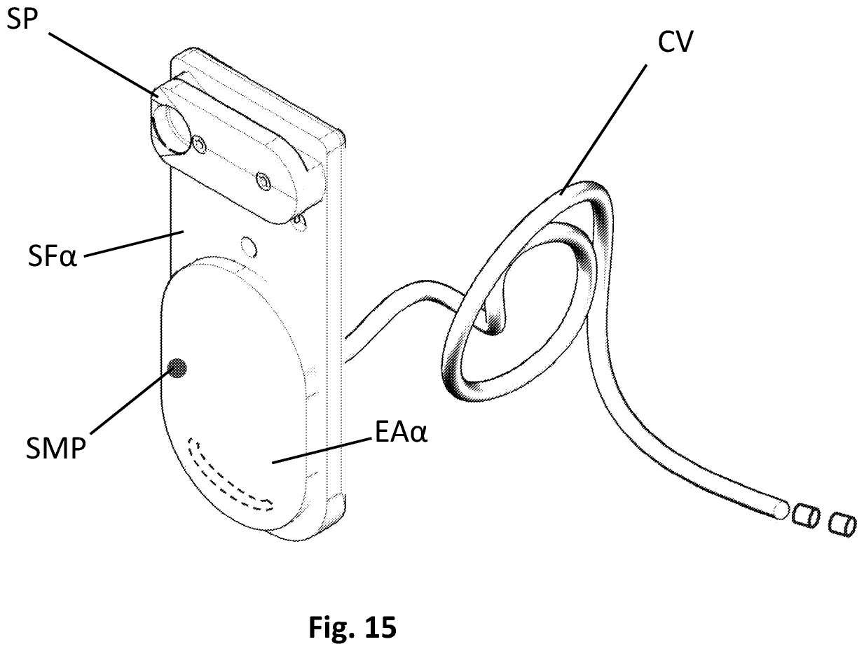

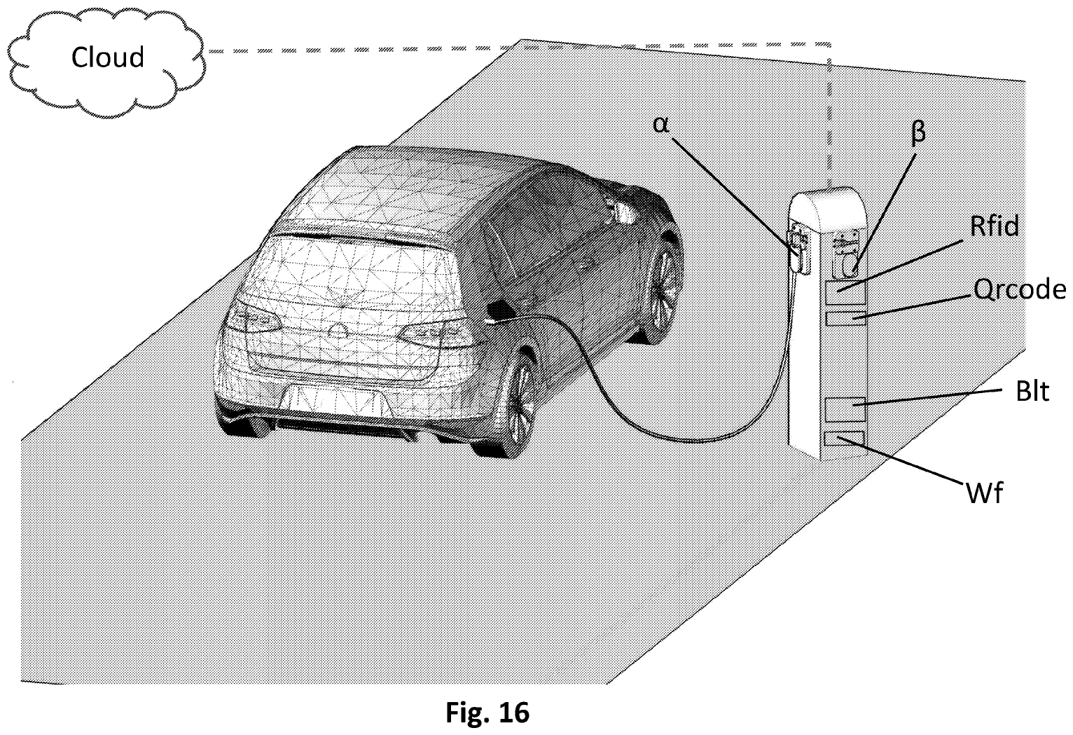

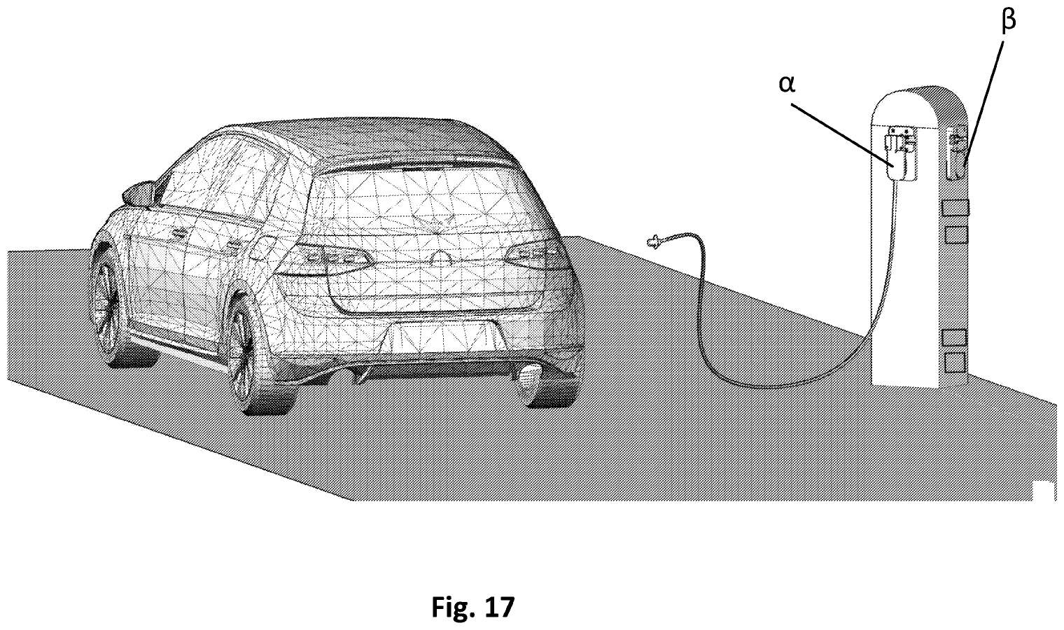

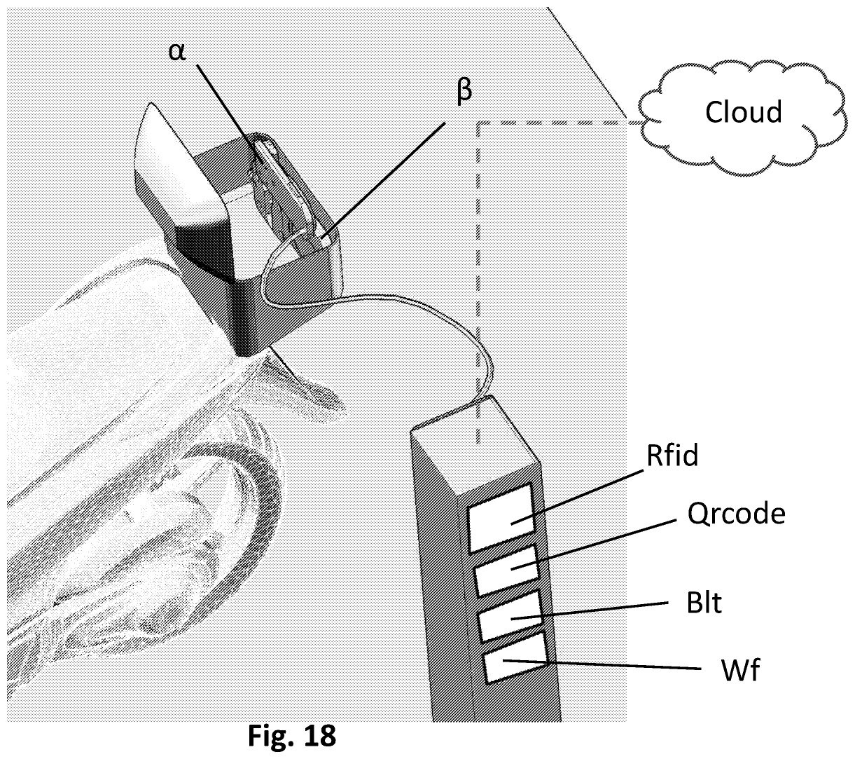

In FIG. 15-16-17 the invention is applied for the WPT car charging:
the cable of the α part of the invention is joint with an appropriate connector to a waiting connector located inside the charging compartment, located on the side of the car and covered by a special hatch;
the β part is rigidly fixed, by screwing the PR bracket, to a parking and charging column;
the user connects the α part to the β part;
the rigid brackets SFα and SFβ are provided with the housings EAα and EAβ of the plates, receiver and transmitter, for the WPT electricity transmission from the charging pillar to the car and/or also for two-way data communication;
the electro-mechanical block CB is operated remotely in-cloud (Cloud), with blocking of the α part, start of recharging and subsequent unlocking of the α part in favor of only authorized users through the implementation of Qrcode hardware and protocols (Qrcode) or Rfid (Rfid), or others.

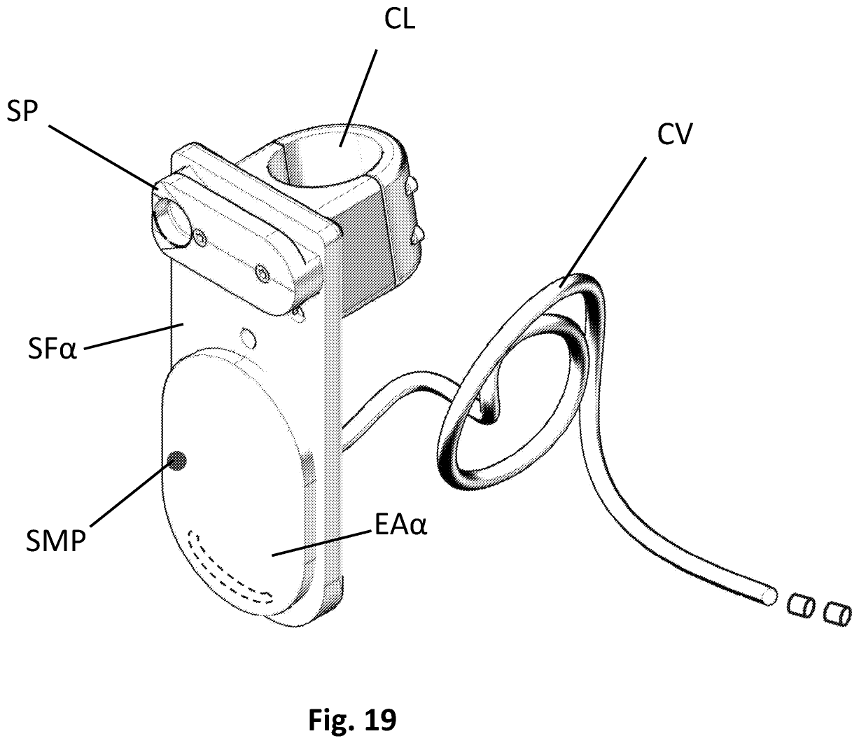

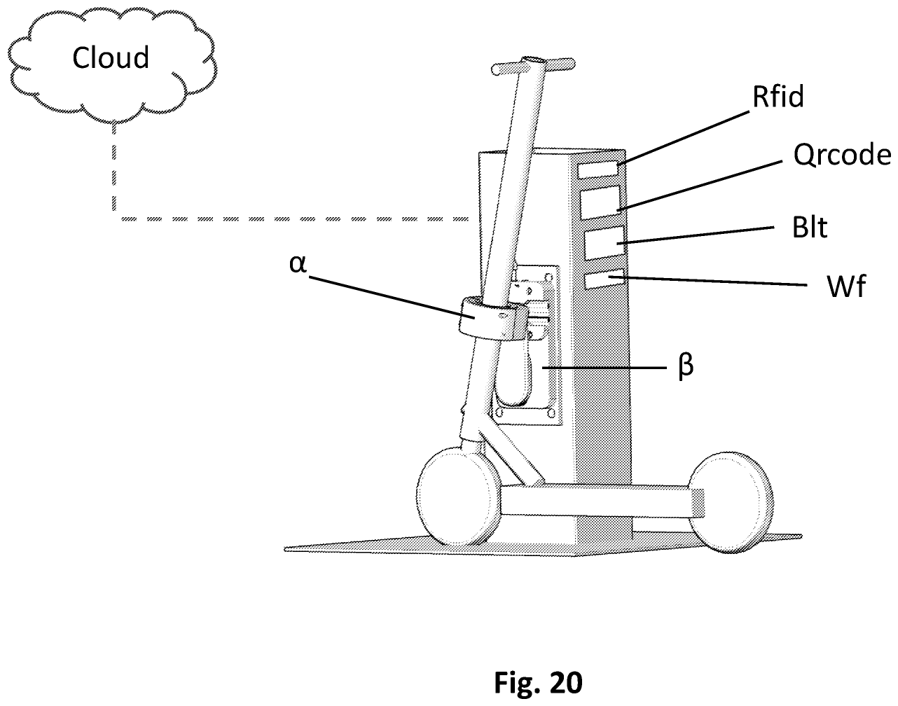

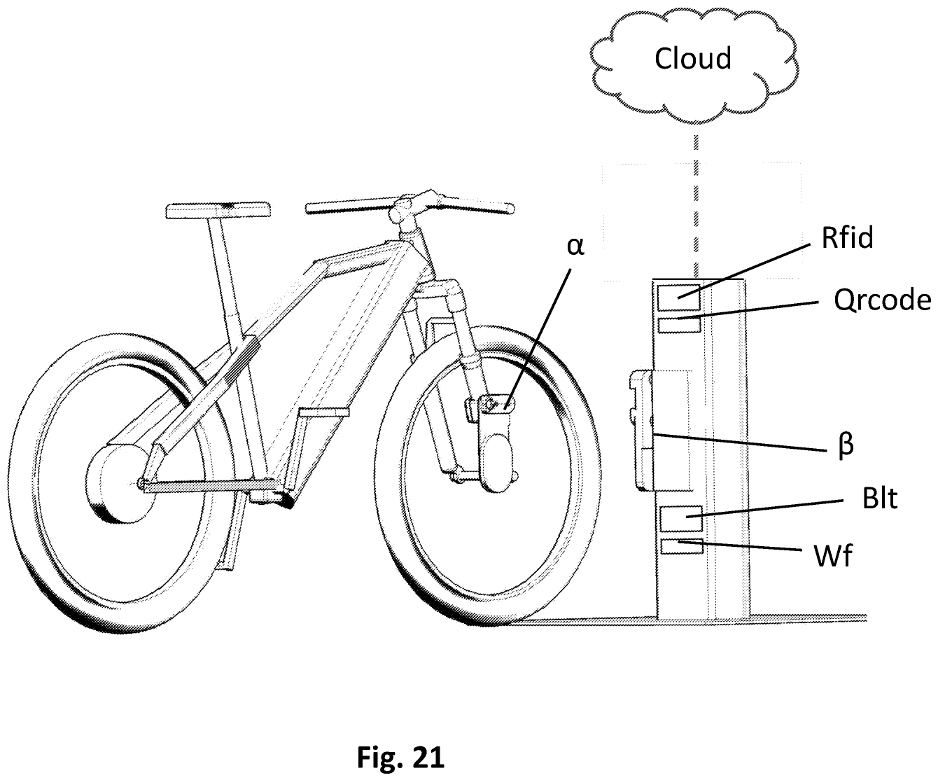

In FIG. 19-20 the invention is applied for the WPT scooter charging:
the part α of the invention is rigidly fixed to an electric scooter rod;
the β part has been rigidly fixed, by screwing the PR bracket, to a parking and charging pillar;
the user connects the α part to the β part by approaching the scooter' rod to the pillar;
the rigid brackets SFα and SFβ are equipped with the EAα and EAβ housings of the receiving and transmitted plates, for the inductive transmission of electrical energy from the charging pillar to the scooter and/or also for two-way communication;
the electro-mechanical block CB is operated remotely in-cloud (Cloud), with blocking of the α part, start of recharging and subsequent unlocking of the α part in favor of only authorized users through the implementation of hardware and protocols Qrcode (Qrcode) or Rfid (Rfid), or others.

1: Static type WPT coupling device with adjustable mechanism of stabilization and locking of a male part (α), composed of a rigid bracket (SFα) to which is rigidly connected a stiff shaped body (SP) and with appropriate thicknesses (SPEA) a plate (EAα) containing WPT receiving coil, to a female part (β) comprising a rigid bracket (SFβ), complete with a guide (GD) functional to the engage and block of said stiff body (SP) of the male part (α), to said rigid bracket (SFβ) is rigidly connected with suitable thicknesses (SPEA) a plate (EAβ) containing WPT electric transmission coil, such that the engage of the rigid body (SP) of the male part (α) and the sliding in the guide (GD) of the rigid bracket (Fβ) of the female part (β), being detected by presence sensors (SMP), determines the action of a piston (PCB), of electro-mechanical block (CB) rigidly connected to the rigid bracket (SFβ) of the female part (β), which crossing (GD) guide through a suitable hole (FCB) blocks (SP) stiff body of the male part (α) in the rigid bracket (SFβ) of the female part (β) in the position in which the receiving plate (EA α) and the transmitting plate (EAβ) are located in the desired specular and parallel correspondence and at the desired inter-distance, optimal for the WPT energy transfer from the said transmitting plate (EAβ) to the said receiving plate (EAα), in which desired specular and parallel correspondence and desired inter-distance remain stably until the disjunction of the male part (α) from the female part (β) of the device, after retraction of the locking piston (PCB) and disengage of the stiff body (SP) of the male part (α) from (GD) guide of the rigid bracket (SFβ) of the device female part (β).

2: Static type WPT coupling device, according to claim 1, with adjustable mechanism of stabilization and locking of a male part (α), composed of a rigid bracket (SFα) to which is rigidly connected a stiff shaped body (SP) and with appropriate thicknesses (SPEA) a plate (EAα) containing WPT receiving coil, to a female part (β) comprising a rigid bracket (SFβ), complete with a (GD) guide functional to the engage and block of (SP) stiff body of the male part (α), to which said rigid bracket (SFβ) is rigidly connected with suitable thicknesses (SPEA) a plate (EAβ) containing WPT electric transmission coil, such that the engage of (SP) rigid body of the male part (α) and the sliding in the (GD) guide of the rigid bracket (SFβ) of the female part (β), determines the relaxation of the release spring of piston (PBM) of electro mechanical locking (BM), rigidly connected to the rigid bracket (SFβ), which locks the (SP) stiff body of the male part (α) in the rigid bracket (SFβ) of the female part (β) in the position where the receiving plate (EAα) and the transmitting plate (EAβ) are in the desired specular and parallel correspondence and at the desired inter-distance, optimal for the WPT energy transfer from the said transmitting plate (EAβ) to the said receiving plate (EAα), in which the desired specular and parallel correspondence and the desired inter-distance remain stably until the disjunction of the male part (α) from the female part (β) of the device, after retraction of the locking piston (PBM) of the electro-mechanical block (BM) and disengaged of (SP) rigid body of the male part (α) from the rigid bracket (SFβ) of the device female part (β).

3: Static type WPT coupling device, according to claim 2, with adjustable mechanism of stabilization and locking of a male part (α), consisting of a rigid bracket (SFα) to which is rigidly connected a stiff shaped body (SP) and with appropriate thicknesses (SPEA) a plate (EAα) containing WPT receiving coil, to a female part (β) comprising a rigid bracket (SFb), complete with a (GD) guide functional to the engage and block of (SP) stiff body of the male part (α), to which said rigid bracket (SFβ) is rigidly connected with suitable thicknesses (SPEA) a plate (EAb) containing WPT electric transmission coil, such that the engage of the rigid body (SP) of the male part (α) and the sliding in the guide (GD) of the rigid bracket (Fβ) of the female part (β), determines the relaxation of the pressure release spring (BS), rigidly connected in the guide (GD) of the rigid bracket (SFβ), which stops mechanically the stiff body (SP) of the male part (α) in said guide (GD) in the position in which the receiving plate (EAα) and the transmitting plate (EAβ) are in the desired specular and parallel correspondence and at the desired inter distance, optimal for the WPT energy transfer from said transmitting plate (EAβ) to said receiving plate (EAα), in which the desired specular and parallel correspondence and the desired inter-distance remain stably until the disjunction of the male part (α) from the female part (β) of the device, after compression of the spring of said presser (BS) upon disengaged of (SP) stiff body of the male part (α) from (GD) guide of the rigid bracket (SFP) of the device female part (β).

4: Static type WPT coupling device according to claim 1 with yielding mechanism with controlled and adjustable deformation for stabilization and blocking of a male part (α), composed of a rigid bracket (SFα) to which is rigidly connected a stiff body (SP) and with appropriate thicknesses (SPEA) a plate (EAα) containing WPT receiving coil, to a female part (β) characterized by inclusion of a rigid bracket (SFβ), complete of a guide (GD) functional to the engage and block of the stiff body (SP) of the male part (α), to which said rigid bracket (SFβ) is rigidly connected with suitable thicknesses (SPEA) a plate (EAβ) containing WPT electric transmission coil, and characterized by inclusion of a further rigid bracket (PR) which parallel to the first (SFβ) is connected to it by one or more elastic elements (PRF), consisting of an elastic body (CR), in natural rubber, or synthetic mix, suitably joined with steel ends for screwing into appropriate holes (FPC) present in the corresponding position on both said rigid brackets (SFβ) and (PR) included in the female part (β).

5: Device according to claim 4 characterized by the fact that the rigid brackets (SFβ and PR) included in the female part (β) are connected to each other by one or more elastic elements (PRF), consisting of an elastic body (CR), in harmonic steel suitably joined to steel ends for screwing into suitable holes (FPC) present in the corresponding position on both said rigid brackets (SFβ) and (PR) included in the female part (β).

6: Static type WPT coupling device according to claim 1 with yielding mechanism with controlled and adjustable deformation for stabilization and blocking of a male part (α), which includes a plate (EAα) containing WPT receiving coil, to a female part (α) which includes a plate (EAβ) containing WPT transmission coil, characterized by the fact that on the rigid bracket (SFβ) included in the female part (β), to which the plate is connected (EAβ), it is rigidly connected also the minor base of a stiff body (FC), consisting of two overlapped concentric base cylinders (FCm, FCM) which crosses the aperture (FFCB) placed in the further rigid bracket (PR), included in the female part (β), and on whose major base it has a protrusion (AF) that limits the rotation of the cylindrical body in the space between the tops of the elastic pins (PRF) that connect the two rigid brackets included in the female part (α), thereby also limiting the rotary component of the roto-translational motion of the bracket (SFβ) to which the plate (EAβ) is connected.

7: Device according to claim 6 characterized by the fact that the said stiff body (FC), consisting of two overlapped concentric base cylinders (FCm, FCM) which crosses through one of the two rigid brackets (PR) of the female part (β) and connects rigidly with the minor base to the other rigid bracket (SFβ) to which the receiving plate (EAβ) is also connected, has a hole (CIF) for the passage of the blocking piston (PCB) of the relative electro-mechanical block (CB) such that the aforementioned electro-mechanical block can be rigidly connected to the major base of the rigid body (FC) itself

8: Device according to claim 1, characterized by the fact that at the ends of the elastic elements (PRF) that connect the two rigid brackets (SFβ and PR) included in the device female part (β), it is possible to apply thickness rings (ASP) useful for the micro-regulation of the roto movements-translative of the rigid bracket (SFβ) in which is recessed the guide (GD) for sliding the rigid body (SP) functional for coupling the male part (α) to the female part (β)

9: Device according to claim 1, characterized by the fact that to the rigid bracket (SFβ) of the female part (α) to which the transmitting plate is connected (EAβ) and to the rigid bracket (SFα) of the male part (α) to which is connected the transmitter plate (EAα) SPEA thicknesses are applicable and/or removable to record the inter-distance between the EAβ transmitting plate and the EAα receiving plate.

10: Device according to claim 1, characterized by the fact that the stiff shaped body (SP) rigidly connected to the rigid bracket (SFα) of the male part (α) is provided with a CL collar, circular or quadratic for its anchoring, rigid and integral to a free body.

11: Device according to claim 1, characterized by the fact that the retraction of the PCB piston is electronically controlled by a plc/pc with various possibilities of interaction also in-cloud.

12: Device according to claim 1, characterized by the fact that the retraction of the PBM piston is controlled manually and electronically by a pic/pc with various possibilities of interaction also in-cloud.

13: Device according to claim 1, characterized by the fact that the rigid bracket (SFβ) of the female part (β) can be connected to the electrical device to be recharged and therefore host a receiving plate and conversely the rigid bracket (SFα) of the male part (α) can connect a transmitting plate.
